(19) United States
(12) Patent Application Publication
(10) Pub. No.: US 2018/0089626 A1
(43) Pub. Date: Mar. 29, 2018

(54) MEMBER QUALIFICATION AND TRACKING

(71) Applicant: LinkedIn Corporation, Mountain View, CA (US)

(72) Inventors: John Phillip Loof, San Francisco, CA (US); Loni Elizabeth Olazaba, San Jose, CA (US); David Mock, Sunnyvale, CA (US)

(21) Appl. No.: 15/278,941

(22) Filed: Sep. 28, 2016

(51) Int. Cl. G06Q 10/10; G06Q 50/00

(52) U.S. Cl. CPC G06Q 10/1053; G06Q 50/01

(57) ABSTRACT

This disclosure relates to systems and methods for member qualifications and tracking. In one example, a method includes storing a member profile for a member of an online social networking service in response to the member applying for an employment position and not being selected for lacking one or more qualifications, the member profile including the lacking qualifications; tracking the member's activity via the online social networking service to determine when the member has rectified the lacking qualifications; and notifying a recruiter associated with the employment position in response to the member rectifying the lacking qualifications.

### TECHNICAL FIELD

The subject matter disclosed herein generally relates to employment and, more particularly, to tracking members to determine when a member satisfies employment qualifications for a position.

### BACKGROUND

As a member of an online social networking service applies for an employment position with a potential employer, they typically pass through a vetting process, which includes analyzing references, accomplishments, qualifications, fitness, etc. In one example, a member applying for an employment position lacks one or more qualifications for the position and is not hired for that reason.

As the member continues his/her career, the member may subsequently qualify for the position. The member and/or potential employer may be unaware of this milestone because the employer and member do not typically remain in contact with each other.

### BRIEF DESCRIPTION OF THE DRAWINGS

Some embodiments are illustrated by way of example and not limitation in the figures of the accompanying drawings.

FIG. 1 is a block diagram illustrating various components or functional modules of an online social networking service, in an example embodiment.

FIG. 2 is a block diagram illustrating a system for member qualification and tracking, according to one example embodiment.

FIG. 3 is a block diagram illustrating another system for member qualification and tracking, according to one example embodiment.

FIG. 4 is a flow chart diagram illustrating a method of member qualification and tracking, according to another example embodiment.

FIG. 5 is a flow chart diagram illustrating another method of member qualification and tracking, according to another example embodiment.

FIG. 6 is a flow chart diagram illustrating another method of member qualification and tracking, according to another example embodiment.

FIG. 7 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

The description that follows includes systems, methods, techniques, instruction sequences, and computing machine program products that embody the inventive subject matter. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Example methods and systems are directed to tracking a member's qualifications for a certain employment position. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A system, as described herein, is configured to receive certain qualifications that disqualify a member for an employment position. As part of a vetting process for the member, an interviewer identifies certain qualifications the member does not possess, but are needed for the employment position. After not being hired, the member may move on to other activities, or may decide to address the identified deficiencies. In one example, the member may register and complete an academic course that satisfies a lacking qualification. The system may then automatically, and without user intervention, notify a recruiter for the employment position that the member now qualifies for the position.

In one example embodiment, the system monitors an educational database to determine that the member registered and completed a course. In certain embodiments, the system receives predefined qualifications and predefined academic courses that address the qualifications. In one example, each qualification is graded at a certain number of levels (e.g., four levels). In one example, an administrator for the system configures four JAVA™ programming language levels. An employment position may require programming level three; however, a member may demonstrate programming level two during an interviewing process. If the member subsequently registers for JAVA™ programming level three and completes the course, the system may automatically notify a recruiter for the position that the member can now program at level three and now qualifies for the position. Of course, other qualifications, levels, etc., may be used and this disclosure is not limited in this regard.

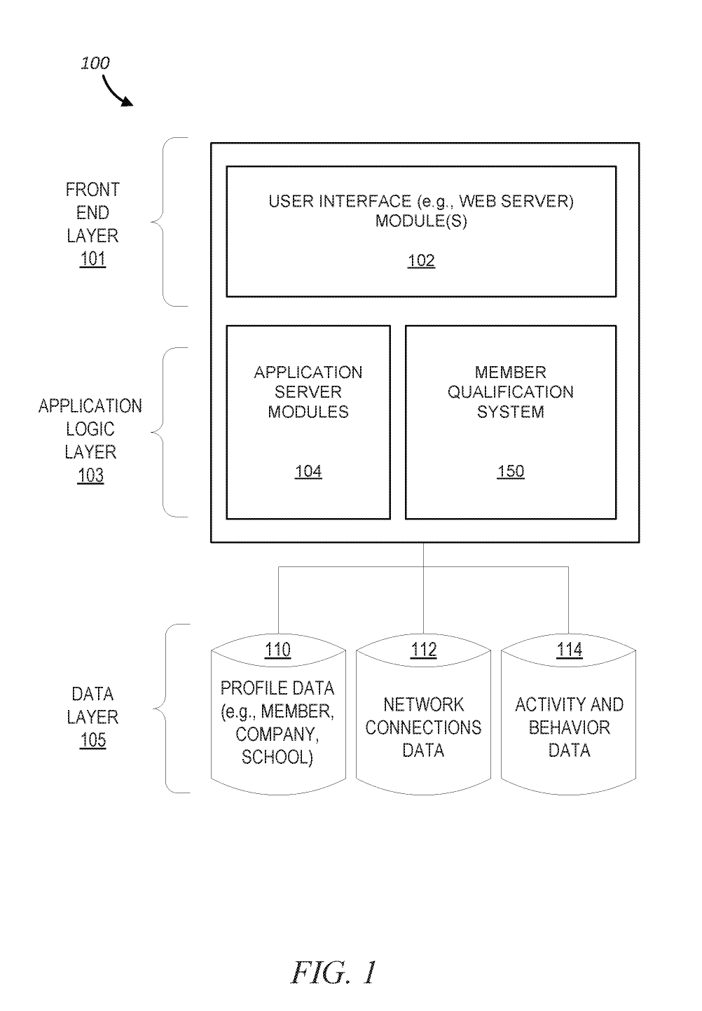

FIG. 1 is a block diagram illustrating various components or functional modules of an online social networking service 100, in an example embodiment.

A front end layer 101 consists of one or more user interface modules (e.g., a web server) 102, which receive requests from various client computing devices and communicates appropriate responses to the requesting client devices. For example, the user interface module(s) 102 may receive requests in the form of Hypertext Transfer Protocol (HTTP) requests, or other web-based, application programming interface (API) requests. In another example, the front end layer 101 receives requests from an application executing via a member's mobile computing device.

An application logic layer 103 includes various application server modules 104, which, in conjunction with the user interface module(s) 102, may generate various user interfaces (e.g., web pages, applications, etc.) with data retrieved from various data sources in a data layer 105. In one example embodiment, the application logic layer 103 includes the member qualification system 150, which stores a member profile for a member of the online social networking service 100 in response to the member applying for an employment position and not being selected for lacking one or more qualifications. In another example embodiment, the member profile includes the lacking qualifications. The member qualification system 150 then tracks the member's activity via the online social networking service 100 to determine when the member has rectified the lacking qualifications. The member qualification system 150 may then notify a recruiter associated with the employment position in response to the member rectifying the lacking qualifications.

In some examples, individual application server modules 104 may be used to implement the functionality associated with various services and features of the online social networking service 100. For instance, the ability of an organization to establish a presence in the social graph of the online social networking service 100, including the ability to establish a customized web page on behalf of an organization, and to publish messages or status updates on behalf of an organization, may be services implemented in independent application server modules 104. Similarly, a variety of other applications or services that are made available to members of the online social networking service 100 may be embodied in their own application server modules 104. Alternatively, various applications may be embodied in a single application server module 104.

As illustrated, the data layer 105 includes, but is not necessarily limited to, several databases 110, 112, 114, such as a database 110 for storing profile data, including both member profile data and profile data for various organizations. The profile data database 110 may also include member profiles to track a member's qualifications for certain employment positions. In certain examples, the user interface modules 102 are configured to monitor network connections between members of the online social networking service 100 and store the connections in the network connections data database 112.

Consistent with some examples, when a person initially registers to become a member of the online social networking service 100, the person may be prompted to provide some personal information, such as his or her name, age (e.g., birthdate), gender, sexual orientation, interests, hobbies, contact information, home town, address, spouse's and/or family members’ names, educational background (e.g., schools, majors, matriculation and/or graduation dates, etc.), occupation, employment history, skills, religion, professional organizations, and other properties and/or characteristics of the member. This information is stored, for example, in the database 110. Similarly, when a representative of an organization initially registers the organization with the online social networking service 100, the representative may be prompted to provide certain information about the organization. This information may be stored, for example, in the database 110, or another database (not shown).

The online social networking service 100 may provide a broad range of other applications and services that allow members the opportunity to share and receive information, often customized to the interests of the member. For example, in some examples, the online social networking service 100 may include a message sharing application that allows members to upload and share messages with other members. In some examples, members may be able to self-organize into groups, or interest groups, organized around subject matter or a topic of interest. In some examples, the online social networking service 100 may host various job listings providing details of job openings within various organizations.

As members interact with the various applications, services, and content made available via the online social networking service 100, information concerning content items interacted with, such as by viewing, playing, and the like, may be monitored, and information concerning the interactions may be stored, for example, as indicated in FIG. 1 by the database 114. In one example embodiment, the interactions are in response to receiving a message requesting the interactions.

Although not shown, in some examples, the online social networking service 100 provides an API module via which third-party applications can access various services and data provided by the online social networking service 100. For example, using an API, a third-party application may provide a user interface and logic that enables the member to submit and/or configure a set of rules used by the member qualification system 150. Such third-party applications may be browser-based applications, or may be operating system specific. In particular, some third-party applications may reside and execute on one or more mobile devices (e.g., phones or tablet computing devices) having a mobile operating system.

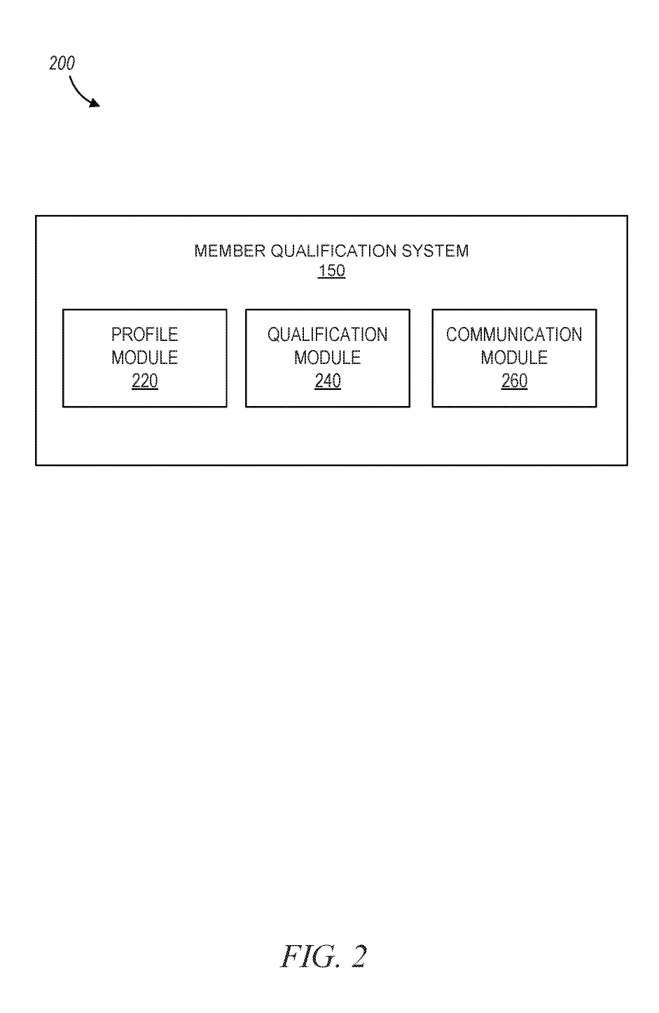

FIG. 2 is a block diagram illustrating a system 200 for member qualification and tracking, according to one example embodiment. As described herein, a qualification at least includes a particular skill or capability that a member either possesses or does not possess. As such, a particular qualification is predefined and, in one example embodiment, includes multiple performance levels. In one example, a qualification of “product management” may include skill levels such as, but not limited to, “no experience, novice, intermediate, or expert.”

Furthermore, each skill level may be predefined to include specific skills or experiences. In one example, a “novice” skill level for “product management” may include exposure to product management, or less than one year experience in product management, while an expert skill level may include 20 years experience, or demonstrated product management success in bringing 10 or more products to market. Of course, other skills and/or skill levels may be predefined and this disclosure is not limited in this regard.

As qualifications (e.g., particular skills) are predefined, an academic institution may configure coursework to address particular qualifications. For example, an academic institution may assemble a course that qualifies a particular member as an “intermediate” “product manager.” In this way, a member may take the course, and upon completion, the member is then qualified as such and meets the particular qualification of being “intermediate” at “product management.”

These predefined qualifications and/or academic courses may also extend to other industries. In other example embodiments, qualifications include: programming languages at various skill levels, graphic design, personnel management, financial management, particular legal skills, gaming skills, typing skills, application usage skills, or any other skill.

In one example embodiment, the member qualification system 150 includes a profile module 220, a qualification module 240, and a communication module 260. The profile module 220, in one example embodiment, is configured to store, using an electronic interface, a member profile for a member of an online social networking service in response to the member applying for an employment position and not being selected for lacking one or more qualifications, the member profile including the lacking qualifications. In one example embodiment, the member profile is the member's profile at the online social networking service 100. In another example embodiment, the member profile is separate from the member's profile at the online social networking service 100.

In one example embodiment, the profile module 220 receives a member profile from an administrator of the online social networking service 100 (e.g., in response to the administrator interviewing the member, identifying a number of lacking qualifications, and entering the lacking qualifications via a user interface). In another example, the profile module 220 generates a member profile based on a member's responses to a test or quiz. In another example embodiment, the profile module 220 receives the member profile by an administrator of the online social networking service 100 manipulating a graphical user interface to configure the member profile. In one example, the member's qualifications are determined based on either correct or incorrect answers to questions on the test. For example, a question may be directed towards a specific skill. In response to a correct response, the member is assigned the qualification. In response to an incorrect response, the member is identified as not having that qualification.

In another example embodiment, the member profile includes information and/or data regarding the member's qualifications. In one example, the member profile includes references, publications, accomplishments, certifications, or the like. In another example embodiment, the member profile includes which, if any, qualifications the member lacked for a particular employment position.

In one example embodiment, the qualification module 240 is configured to track the member's activity via the online social networking service 100 to determine when the member has rectified the lacking qualifications.

In one example embodiment, the qualification module 240 monitors the member's profile and in response to the member altering his/her profile to indicate that the qualification has been met, the qualification module 240 determines that the member now satisfies the qualification. In one example, the qualification module 240 checks the member's profile periodically. For example, hourly, daily, weekly, monthly, and the like. In another example, the qualification module 240 is notified of a change to the member's profile and the qualification module 240 reads the member's profile to determine whether a lacking qualification has been satisfied.

In another example embodiment, the qualification module 240 evaluates the member's qualifications against requirements for the employment position in response to the member indicating interest in another employment position via the online social networking service 100. In one example, the member indicates interest by clicking on a link to view other employment opportunities.

In one example embodiment, the qualification module 240 identifies one or more academic courses that rectify the lacking qualifications and notifies the member regarding the academic courses. In one example, the qualification module 240 compares qualifications for an employment position against the qualifications attributed to the member and determines a difference. Each qualification required by the position that the member has not satisfied is a lacking qualification. In response, the qualification module 240 identifies an academic course for each lacking qualification and sends a message to the member that iterates the needed courses to satisfy the qualifications for the employment position.

In another example embodiment, the qualification module 240 updates the member's profile at the online social networking service 100 in response to the member completing a course that addresses a lacking qualification. For example, in response to the member completing a course that satisfies a qualification of “expert” level “algorithms,” the qualification module 240 updates the member's social network profile to indicate that the member is an expert in algorithms.

In one example embodiment, the qualification module 240 scores the member according to how the member's qualifications match qualification for an employment position. In one example, the qualification module 240 scores the member using a percentage of qualifications for a position that are met by the qualifications of the member. In one example, an employment position has 10 qualifications. In response to the member satisfying nine of the qualifications, the qualification module 240 assigns a score of 90% to the member. In another example embodiment, the qualification module 240 uses a keyword lookup to determine which qualification are required by the position but are not met by the member.

In another example embodiment, the qualification module 240 increases a score for a member for a certain qualification in response to the member taking a course that addresses a lacking qualification. Although the member may not pass the course, the demonstrated commitment in taking the course may indicate the member's desire to learn lacking qualifications. In one example, the qualification module 240 increases a member's skill level by a predetermined amount (e.g., 0.5) in response to taking a course.

In one example embodiment, the communication module 260 is configured to notify a recruiter associated with the employment position in response to the member rectifying the lacking qualifications. In one example, the qualification module 240 indicates to the communication module 260 that the member has rectified one or more qualifications and the communication module 260 informs the recruiter. In one example, the communication module 260 emails the recruiter. In another example, the communication module 260 transmits a message in another way. Of course, one skilled in the art having the benefit of the present disclosure may recognize many other ways in which the communication module 260 may notify the recruiter and this disclosure is meant to include all such ways. In other embodiments, the communication module 260 transmits a message using an electronic interface to a messaging system.

In another example embodiment, the communication module 260 generates a graphical view comparing the qualification of the member and the qualification required for the position. In one example, the graphical view includes a bar chart of the qualifications. In another example, the graphical view includes a list of the qualifications with checks by qualifications that are satisfied. Of course, one skilled in the art may recognize other ways to display a difference in qualifications and this disclosure is meant to include all such ways.

In one example embodiment, the communication module 260 generates a view that depicts a difference in qualification between when the member first applied for the position and a current qualification state of the member. In one example, the communication module 260 generates a pie chart of current qualifications wherein previous qualifications do not fill the pie chart.

In another example embodiment, the communication module 260 notifies the member that the member has qualified for the employment position in response to the member rectifying the lacking qualifications. In one example, in response to the member completing a course that satisfies a last lacking qualification, the communication module 260 alerts the member that the qualifications are now met for a position previously applied to.

In one example embodiment, the communication module 260 notifies the recruiter when a certain score threshold is met for a particular qualification. In another example, the communication module 260 notifies the recruiter in response to the member completing all qualifications for a position previously applied to.

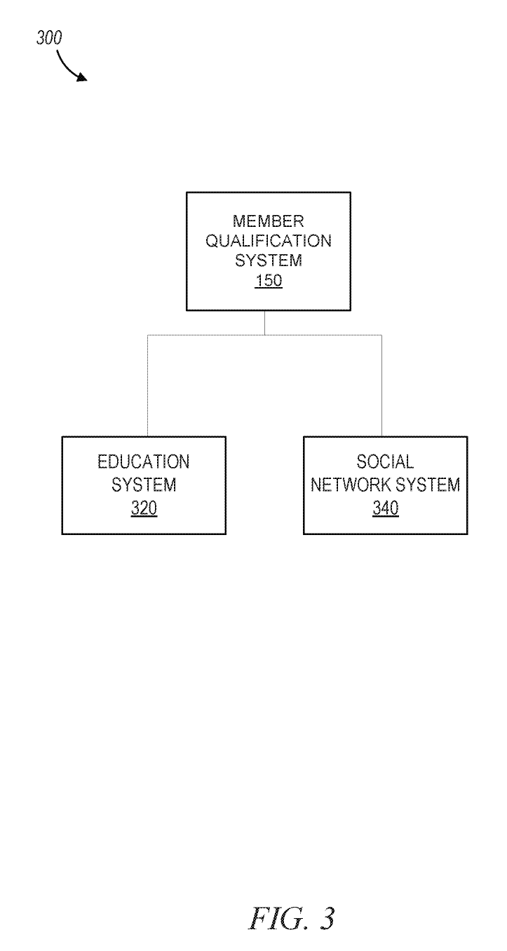

FIG. 3 is a block diagram illustrating another system 300 for member qualification and tracking, according to one example embodiment. In this example embodiment, the member qualification system 150 communicates with a social network system 340 and an education system 320.

In one example embodiment, the social network system 340 is substantially similar to the online social networking service 100; however, this is not necessarily the case. In this example embodiment, the profile module 220 communicates with the social network system 340 over a network connection to retrieve an application profile for a member that includes the qualifications of the member. The member qualification system 150 may also store a list of qualifications needed for a position that the member does not satisfy. In another example embodiment, the qualification module 240 communicates with the education system 320 to determine whether the member has completed a course that addresses one or more lacking qualifications.

In another example embodiment, the member qualification system 150, the social network system 340, and the education system 320 communicate electronically (e.g., wired or wirelessly) without user intervention and notify an administrator in response to a member satisfying lacking qualifications for an employment position previously applied to.

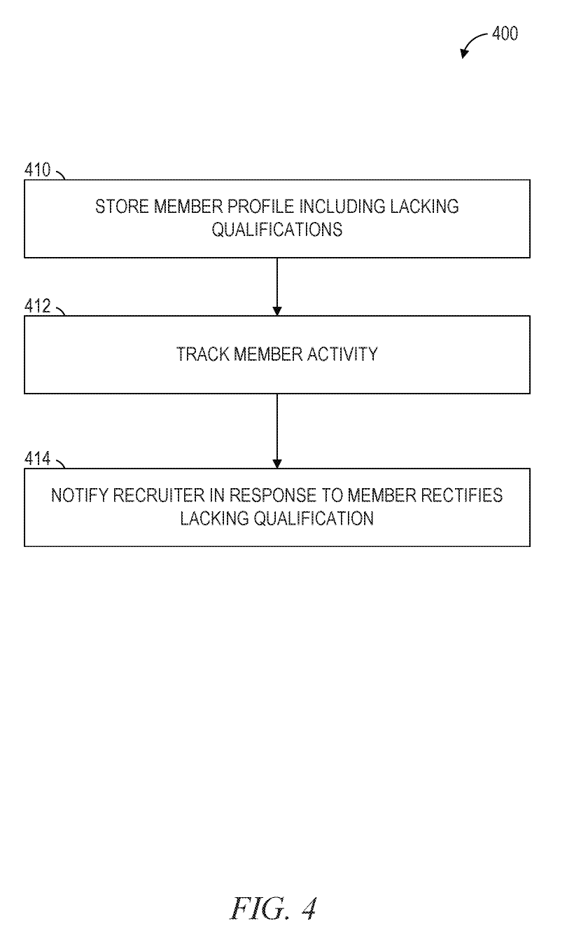

FIG. 4 is a flow chart diagram illustrating a method of member qualification and tracking, according to another example embodiment. According to one example embodiment, the method 400 is performed by one or more modules of the member qualification system 150 and is described by a way of reference thereto.

In one example embodiment, the method 400 begins and at operation 410, the profile module 220 stores a member profile for a member of an online social networking service (e.g., online social networking service 100) in response to the member applying for an employment position and not being selected for lacking one or more qualifications. In one example embodiment, the profile module 220 uses an electronic interface. For example, the profile module 220, in one embodiment, transmits the lacking qualification(s) to a remote database for storage. In another example embodiment, the member profile includes lacking qualifications for an employment position.

The method 400 continues at operation 412 and the qualification module 240 tracks the member's activity via the online social networking service 100 to determine when the member has rectified the lacking qualifications. In one example, the qualification module 240 reads the member's social network profile at the online social networking service 100 and compares qualifications with qualifications for the employment position.

The method 400 continues at operation 414 and the communication module 260 notifies a recruiter, as described herein, associated with the employment position in response to the member rectifying the lacking qualifications.

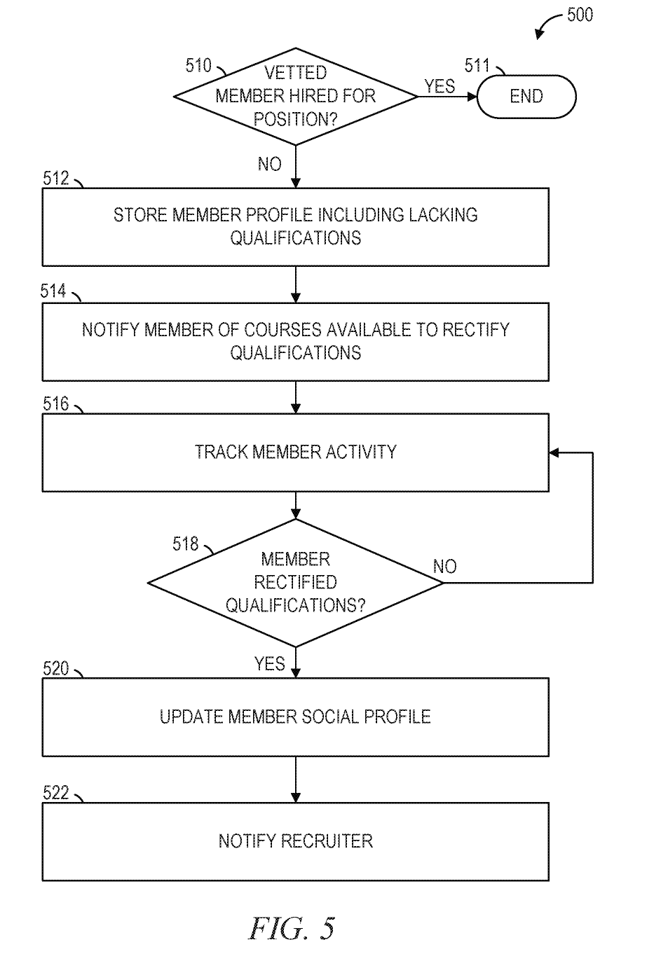

FIG. 5 is a flow chart diagram illustrating another method 500 of member qualification and tracking, according to another example embodiment. According to one example embodiment, the method 500 is performed by one or more modules of the member qualification system 150 and is described by a way of reference thereto.

In one example embodiment, the method 500 begins and at operation 510, the profile module 220 determines whether a member that applied for an open position was hired. In one example, the profile module 220 looks up whether the member was hired in a remote database. In response to the member being hired, the method 500 ends at operation 511.

In response to the member not being hired, the method 500 continues at operation 512 and the profile module 220 stores a profile for the member. In one example, the profile module 220 writes a file representing the qualifications of the position, the qualifications of the member, and the lacking qualifications in a file on a storage device.

The method 500 continues at operation 514 and the communication module 260 notifies the member which courses are available (e.g., via an education system 320) to satisfy lacking qualifications. In one example, a member was not hired because he/she lacked design skills at a certain level and the communication module 260 notifies the member which course may be taken to satisfy the lacking qualification.

The method 500 continues at operation 516 and the qualification module 240 tracks the member's activity at the online social networking service 100 as described herein. The method 500 continues at operation 518 and the qualification module 240 determines whether the member has rectified the lacking qualifications. In one example, the qualification module 240 retrieves course data from an academic institution (e.g., education system 320).

In response to the member not satisfying lacking qualifications, the method 500 continues at operation 516. In response to the member satisfying lacking qualifications by completing one or more courses, the method 500 continues to operation 520 and the profile module 220 updates the member's profile at the online social networking service 100. The method 500 continues at operation 522 and the communication module 260 notifies a recruiter for the position in any way as described herein.

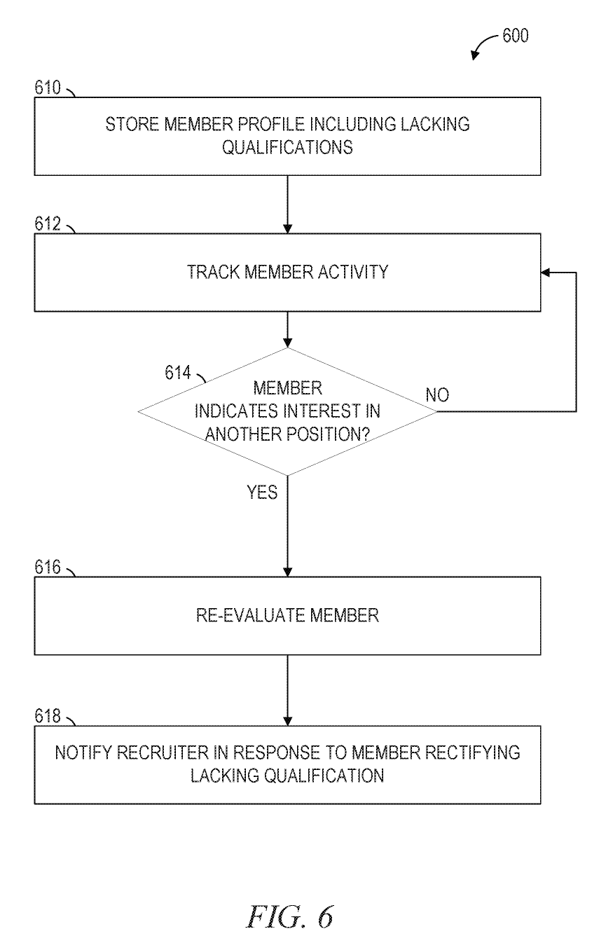

FIG. 6 is a flow chart diagram illustrating another method 600 of member qualification and tracking, according to another example embodiment. According to one example embodiment, the method 600 is performed by one or more modules of the member qualification system 150 and is described by a way of reference thereto.

The method 600 begins and at operation 610 the profile module 220 stores a profile for the member. In one example, the profile module 220 adds a record to a database that includes the qualifications of the position, the qualifications of the member, and the lacking qualifications.

The method 600 continues at operation 612 and the qualification module 240 tracks the member's activity by periodically requesting a list of the member's qualifications from a remote server. In one example, the remote server is configured to accept electronic requests using an API.

The method 600 continues at operation 614 and the qualification module 240 determines whether the member is currently interested in another employment position. In one example, the member applies, using the online social networking service 100, for another position.

The method 600 continues at operation 616 and the qualification module 240 re-evaluates the member by comparing the member's current qualifications with the qualifications for the position previously applied for. The method 600 continues at operation 618 and in response to the member rectifying lacking qualifications for the position previously applied for, the communication module 260 notifies the recruiter for the position that the member is now qualified for the previous position.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications, and so forth described in conjunction with FIGS. 1-4 are implemented in some embodiments in the context of a machine and an associated software architecture. The sections below describe a representative architecture that is suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

### Example Machine Architecture and Machine-Readable Medium

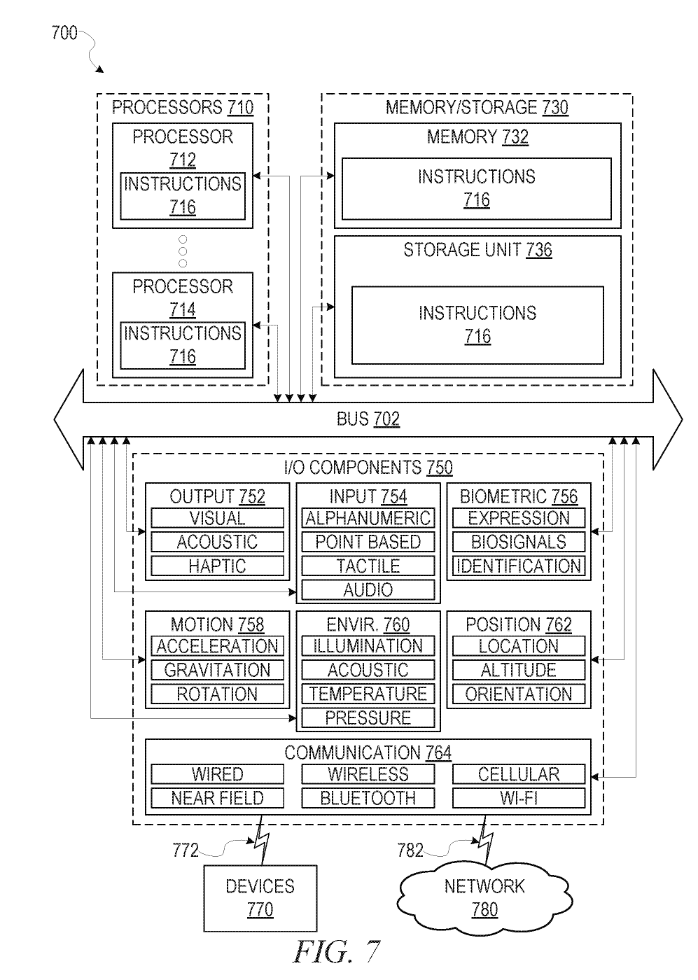

FIG. 7 is a block diagram illustrating components of a machine, according to some example embodiments, able to read instructions from a machine-readable medium (e.g., a machine-readable storage medium) and perform any one or more of the methodologies discussed herein.

Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. For example the instructions 716 may cause the machine 700 to execute the flow diagrams of FIGS. 4-6. Additionally, or alternatively, the instructions 716 may implement one or more of the components of FIG. 2. The instructions 716 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a personal digital assistant (PDA), or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory/storage 730, and I/O components 750, which may be configured to communicate with each other such as via a bus 702. In an example embodiment, the processors 710 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 712 and a processor 714 that may execute the instructions 716. The term “processor” is intended to include multi-core processors 710 that may comprise two or more independent processors (sometimes referred to as “cores”) that may execute instructions contemporaneously. Although FIG. 7 shows multiple processors 710, the machine 700 may include a single processor with a single core, a single processor with multiple cores (e.g., a multi-core processor), multiple processors with a single core, multiple processors with multiples cores, or any combination thereof.

The memory/storage 730 may include a memory 732, such as a main memory, or other memory storage, and a storage unit 736, both accessible to the processors 710 such as via the bus 702. The storage unit 736 and memory 732 store the instructions 716 embodying any one or more of the methodologies or functions described herein. The instructions 716 may also reside, completely or partially, within the memory 732, within the storage unit 736, within at least one of the processors 710 (e.g., within the processor's cache memory), or any suitable combination thereof, during execution thereof by the machine 700. Accordingly, the memory 732, the storage unit 736, and the memory of the processors 710 are examples of machine-readable media.

As used herein, “machine-readable medium” means a device able to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 716. The term “machine-readable medium” shall also be taken to include any medium, or combination of multiple media, that is capable of storing instructions (e.g., instructions 716) for execution by a machine (e.g., machine 700), such that the instructions, when executed by one or more processors of the machine 700 (e.g., processors 710), cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 750 may include a wide variety of components to receive input, provide output, produce output, transmit information, exchange information, capture measurements, and so on. The specific I/O components 750 that are included in a particular machine 700 will depend on the type of machine. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion and the grouping is in no way limiting. In various example embodiments, the I/O components 750 may include output components 772 and input components 754. The output components 752 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 750 may include biometric components 756, motion components 758, environmental components 760, or position components 762 among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 762 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via coupling 782 and coupling 772 respectively. For example, the communication components 764 may include a network interface component or other suitable device to interface with the network 780. In further examples, the communication components 764 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a Universal Serial Bus (USB)).

Moreover, the communication components 764 may detect identifiers or include components operable to detect identifiers. For example, the communication components 764 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may he derived via the communication components 764, such as location via Internet Protocol (IP) geolocation, location via Wi-Fi® signal triangulation, location via detecting an NFC beacon signal that may indicate a particular location, and so forth.

### Transmission Medium

In various example embodiments, one or more portions of the network 780 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 780 or a portion of the network 780 may include a wireless or cellular network and the coupling 782 may be a Code Division Multiple Access (CDMA) connection, a Global System for Mobile communications (GSM) connection, or another type of cellular or wireless coupling. In this example, the coupling 782 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 716 may be transmitted or received over the network 780 using a transmission medium via a network interface device (e.g., a network interface component included in the communication components 764) and utilizing any one of a number of well-known transfer protocols (e.g., HTTP). Similarly, the instructions 716 may be transmitted or received using a transmission medium via the coupling 772 (e.g., a peer-to-peer coupling) to the devices 770. The term “transmission medium” shall be taken to include any intangible medium that is capable of storing, encoding, or carrying the instructions 716 for execution by the machine 700, and includes digital or analog communications signals or other intangible media to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A system comprising:
a machine-readable medium having instructions stored thereon, which, when executed by a processor, performs operations comprising:
storing, using an electronic interface, a member profile for a member of an online social networking service in response to the member applying for an employment position and not being selected for lacking one or more qualifications, the member profile indicating the lacking qualifications;
tracking the member's activity via the online social networking service to determine when the member has rectified the lacking qualifications; and
notifying a recruiter associated with the employment position in response to the member rectifying the lacking qualifications.

2. The system of claim 1, wherein the operations further comprise notifying the member that the member has qualified for the employment position in response to the member rectifying the lacking qualifications.

3. The system of claim 1, wherein the operations further comprise re-evaluating the member's qualifications against the employment position in response to the member indicating interest in another employment position via the online social networking service.

4. The system of claim 1, wherein the one or more qualifications are selected from a predefined set of qualifications.

5. The system of claim 1, wherein the operations further comprise identifying one or more academic courses that rectify the lacking qualifications and notifying the member regarding the academic courses.

6. The system of claim 1, wherein the operations further comprise updating the member's member profile in response to the member completing a course that addresses a lacking qualification.

7. The system of claim 1, wherein the operations further comprise determining that the member has satisfied the lacking qualifications in response to the member completing a course configured to satisfy the lacking qualifications.

8. A method comprising:
storing, using an electronic interface, a member profile for a member of an online social networking service in response to the member applying for an employment position and not being selected for lacking one or more qualifications, the member profile indicating the lacking qualifications;
tracking the member's activity via the online social networking service to determine when the member has rectified the lacking qualifications; and
notifying a recruiter associated with the employment position in response to the member rectifying the lacking qualifications.

9. The method of claim 8, further comprising notifying the member that the member has qualified for the employment position in response to the member rectifying the lacking qualifications.

10. The method of claim 8, further comprising re-evaluating the member's qualifications against the employment position in response to the member indicating interest in another employment position via the online social networking service.

11. The method of claim 8, wherein the one or more qualifications are selected from a predefined set of qualifications.

12. The method of claim 8, further comprising identifying one or more academic courses that rectify the lacking qualifications and notifying the member of the academic courses.

13. The method of claim 8, further comprising updating the member's member profile in response to the member completing a course that addresses a lacking qualification.

14. The method of claim 8, further comprising determining that the member has satisfied the lacking qualifications in response to the member completing a course configured to satisfy the lacking qualifications.

15. A machine-readable hardware medium having instructions stored thereon, which, when executed by a processor, cause the processor to perform:
storing, using an electronic interface, a member profile for a member of an online social networking service in response to the member applying for an employment position and not being selected for lacking one or more qualifications, the member profile indicating the lacking qualifications;
tracking the member's activity via the online social networking service to determine when the member has rectified the lacking qualifications; and
notifying a recruiter associated with the employment position in response to the member rectifying the lacking qualifications.

16. The machine-readable hardware medium of claim 15, wherein the instructions further cause the processor to notify the member that the member has qualified for the employment position in response to the member rectifying the lacking qualifications.

17. The machine-readable hardware medium of claim 15, wherein the instructions further cause the processor to re-evaluate the member's qualifications against the employment position in response to the member indicating interest in another employment position via the online social networking service.

18. The machine-readable hardware medium of claim 15, wherein the one or more qualifications are selected from a predefined set of qualifications.

19. The machine-readable hardware medium of claim 15, wherein the instructions further cause the processor to identify one or more academic courses that rectify the lacking qualifications and notifying the member of the academic courses.

20. The machine-readable hardware medium of claim 15, further comprising determining that the member has satisfied the lacking qualifications in response to the member completing a course configured to satisfy the lacking qualifications.
